(19) United States
(12) Patent Application Publication
(10) Pub. No.: US 2010/0155379 A1
(43) Pub. Date: Jun. 24, 2010

(54) ILLUMINATION METHODS AND SYSTEMS FOR LASER SCRIBE DETECTION AND ALIGNMENT IN THIN FILM SOLAR CELL FABRICATION

(75) Inventor: Bassam Shamoun, Fremont, CA (US)

Correspondence Address: TOWNSEND AND TOWNSEND AND CREW LLP, TWO EMBARCADERO CENTER, EIGHTH FLOOR, SAN FRANCISCO, CA, 94111-3834, US

(73) Assignee: Applied Materials, Inc., Santa Clara, CA (US)

(21) Appl. No.: 12/642,378

(22) Filed: Dec. 18, 2009

Related U.S. Application Data
(60) Provisional application No. 61/139,376, filed on Dec. 19, 2008.

(51) Int. Cl. B23K 26/36; G01B 11/14

(52) U.S. Cl. 219/121.68; 356/614; 219/121.78

(57) ABSTRACT

Combined illumination is used to detect the positions of features such as scribe lines in different layers of a workpiece. Because combinations of layers of different material can scatter, reflect, scatter, and/or transmit light in different ways, combining and adjusting such illumination can allow positions of multiple features to be detected concurrently, such that the position of a feature being formed in one layer can be adjusted to a relative position with respect to a feature in another layer, even where those layers are of different materials with different optical properties.

### CROSS-REFERENCES TO RELATED APPLICATIONS

This application claims the benefit of U.S. Provisional Patent Application No. 61/139,376, filed on Dec. 19, 2008, entitled “Illumination Approaches for Scribing Systems,” the entire disclosure of which is hereby incorporated herein by reference.

### BACKGROUND

Various embodiments described herein relate generally to the scribing of materials, as well as methods and systems for scribing of materials. These methods and systems may be particularly effective in scribing single junction solar cells and thin-film multi junction solar cells.

Current methods for forming thin-film solar cells involve depositing or otherwise forming a plurality of layers on a substrate, such as a glass, metal or polymer substrate suitable to form one or more p-n junctions. An example of a solar cell has an oxide layer (e.g., a transparent-conductive-oxide (TCO) layer) deposited on a substrate, followed by an amorphous-silicon layer and a metal back layer. Examples of materials that can be used to form solar cells, along with methods and apparatus for forming the cells, are described, for example, in co-pending U.S. patent application Ser. No. 11/671,988, filed Feb. 6, 2007, entitled “MULTI-JUNCTION SOLAR CELLS AND METHODS AND APPARATUSES FOR FORMING THE SAME,” which is hereby incorporated herein by reference. When a panel is formed from a large substrate, a series of scribe lines is typically used within each layer to delineate the individual cells. In previous approaches, scribing methods and systems may fail to accurately account for variations in the scribe lines, and/or may fail to provide approaches to perform minor adjustments to minimize deviations from intended scribe-line positions.

Accordingly, it is desirable to develop methods and systems that overcome at least some of these, as well as potentially other, deficiencies in existing scribing and solar panel manufacturing methods and systems.

### BRIEF SUMMARY

Methods and systems are provided for feature detection using combined illumination. The disclosed methods and systems can be used to detect lines scribed in multi-layered substrates used in thin-film multi junction solar cells. In many embodiments, a multi-layered substrate is illuminated from above and below, and a detector is used to concurrently detect the position of multiple features. Such detection can be used to adjust a relative position of a feature being formed on one layer with respect to a feature in another layer, even when the layers involved are of different materials with different optical properties. The ability to accurately faun a scribe line at a controlled distance from an existing scribe line may increase the efficiency of resulting solar cell panels.

Thus, in a first aspect, a method for measuring a position of at least one scribed feature on a workpiece is provided, the workpiece including at least one layer used for forming a solar cell. The method includes illuminating the workpiece from a first side of the workpiece with at least one of a first illumination device in a direction substantially perpendicular to the workpiece or a second illumination device that emits angled illumination for dark-field illumination of the workpiece, illuminating the workpiece with a third illumination device from a second side of the workpiece and in a direction substantially perpendicular to the workpiece, and measuring the amount of light from at least one of the first illumination device or the second illumination device that has been reflected from the workpiece and from the third illumination device that has been transmitted through the workpiece so as to determine a position of at least one scribed feature on the workpiece. The second side is opposite the first side.

In many embodiments, the method for measuring a position involves at least one additional feature and/or step. For example, the step of illuminating the workpiece from a first side of the workpiece can include emitting angled illumination for dark-field illumination of the workpiece. The second illumination device can emit light directed between 25 and 30 degrees from perpendicular to the workpiece. The second illumination device can include a ring light. The first illumination device can be integrated with a laser-scanning assembly so that illumination is projected from the laser-scanning assembly. Illuminating the workpiece with a third illumination device can include reflecting illumination light onto the workpiece with a reflector. A detector can be disposed on the first side of the workpiece so as to accomplish the stated step of measuring light. The detector can be integrated within a laser-scanning assembly so that the light measured by the detector is at least partially transmitted through the laser-scanning assembly. The detector can include a charge-coupled-device (CCD) sensor. The stated step of measuring light can include measuring light intensities.

In another aspect, an article is provided that includes a storage medium having instructions stored thereon that when executed result in the performance of a method for measuring a position of at least one scribed feature on a workpiece. The method includes illuminating the workpiece from a first side of the workpiece by using at least one of a first illumination device that illuminates the workpiece in a direction substantially perpendicular to the workpiece or a second illumination device that emits angled illumination for dark-field illumination of the workpiece, illuminating the workpiece with a third illumination device from a second side of the workpiece and in a direction substantially perpendicular to the workpiece, and measuring the amount of light from at least one of the first illumination device or the second illumination device that has been reflected from the workpiece and from the third illumination device that has been transmitted through the workpiece so as to determine a position of at least one scribed feature on the workpiece. The second side is opposite the first side.

In another aspect, a system for measuring a position of at least one scribed feature on a workpiece is provided, the workpiece including a substrate and at least one layer used for forming a solar cell. The system includes a laser generating output able to remove material from at least a portion of a workpiece, at least one of a first illumination device operable to illuminate the workpiece from a first side of the workpiece and in a direction substantially perpendicular to the workpiece or a second illumination device operable to illuminate the workpiece by emitting angled illumination for dark-field illumination of the workpiece, a third illumination device operable to illuminate the workpiece from a second side of the workpiece and in a direction substantially perpendicular to the workpiece, and at least one detector operable to measure an amount of light from at least one of the first illumination device or the second illumination device that has been reflected from the workpiece and from the third illumination device that has been transmitted through the workpiece. The laser is disposed on the first side of the workpiece. The second side is opposite the first side. The detector is further operable to generate a signal corresponding to a position of at least one scribed feature on the workpiece.

In many embodiments, the system includes one or more additional features and/or provides additional functionality. For example, the system can further include a processor and a memory including instructions that when executed by the processor enable the system to analyze the signal from the detector to determine a position of the at least one scribed feature on the workpiece. Analyzing the signal from the detector can include determining light intensities. The system can further include a scanning device operable to control a position of the output from the laser. The scanning device can be integrated within a laser-scanning assembly, and the first illumination device can be integrated with the laser-scanning assembly so that illumination is projected from the scanning device. The memory can further include instructions that when executed by the processor enable the system to adjust the position of the output from the laser in order to adjust a relative position of a feature being formed on the workpiece. The scanning device can be operable to control the position of the output from the laser in two dimensions. The scanning device can be integrated with a laser-scanning assembly, and at least one detector of the at least one detector can be integrated with the laser-scanning assembly so that light measured by the detector includes light transmitted through the scanning device. The at least one detector can include a charge-coupled-device (CCD) sensor. The second illumination device can emit light directed between 25 and 30 degrees from perpendicular to the workpiece. The second illumination device can include a ring light.

For a fuller understanding of the nature and advantages of the present invention, reference should be made to the ensuing detailed description and accompanying drawings. Other aspects, objects and advantages of the invention will be apparent from the drawings and detailed description that follows.

### BRIEF DESCRIPTION OF THE DRAWINGS

FIG. 1 illustrates a perspective view of a laser-scribing device, in accordance with many embodiments.

FIG. 2 illustrates a side view of a laser-scribing device, in accordance with many embodiments.

FIG. 3 illustrates a set of laser assemblies, in accordance with many embodiments.

FIG. 4 illustrates components of a laser assembly, in accordance with many embodiments.

FIG. 5 illustrates a laser-scribing device having a combination of illumination sources, in accordance with many embodiments.

FIG. 6 diagrammatically illustrates illumination source locations and the integration of a camera with a laser-scanning assembly, in accordance with many embodiments.

FIG. 7 illustrates incident and reflected light after formation and scribing of a first layer on a substrate, in accordance with many embodiments.

FIG. 8 illustrates incident and reflected light for collinear illumination after formation and scribing of a second layer on a substrate, in accordance with many embodiments.

FIG. 9 illustrates a plot corresponding to measured light for the collinear illumination of the configuration of FIG. 8, in accordance with many embodiments.

FIG. 10 illustrates incident, reflected, and transmitted light for back illumination after formation and scribing of a second layer on a substrate, in accordance with many embodiments.

FIG. 11 illustrates plot corresponding to measured light for the collinear illumination and back illumination of the configuration of FIGS. 8 and 10, in accordance with many embodiments.

FIG. 12 illustrates incident, reflected, and transmitted light for collinear illumination and back illumination after formation and scribing of a second layer on a substrate, in accordance with many embodiments.

FIG. 13 illustrates a plot corresponding to measured light for the collinear illumination and back illumination of the configuration of FIG. 12, in accordance with many embodiments.

FIG. 14 illustrates incident, reflected, and transmitted light for collinear illumination and back illumination after formation and scribing of a third layer on a substrate, in accordance with many embodiments.

FIG. 15 illustrates a plot corresponding to measured light for the collinear illumination and back illumination of the configuration of FIG. 14, in accordance with many embodiments.

FIG. 16 illustrates an illumination configuration having a bar reflector, in accordance with many embodiments.

FIG. 17 illustrates a detection signal having a poor signal-to-noise ratio corresponding to a P2 scribe line in the presence of a metal back layer, in accordance with many embodiments.

FIG. 18 illustrates the use of a ring light to emit angled illumination for dark-field illumination of a workpiece, in accordance with many embodiments.

FIG. 19A shows an image of adjacent P2 and P3 scribe lines obtained using a ring light for dark-field illumination of a workpiece, in accordance with many embodiments.

FIG. 19B presents a detection signal for a cross-section of the image of FIG. 19A that exhibits a good signal-to-noise ratio corresponding to a P2 scribe line, in accordance with many embodiments.

FIG. 20 illustrates a cross section of a solar device that can be formed using laser-scribing devices in accordance with many embodiments.

FIG. 21 illustrates a longitudinal scan technique that can be used in accordance with many embodiments.

### DETAILED DESCRIPTION

Methods and systems in accordance with many embodiments of the present disclosure can overcome one or more of the aforementioned and other deficiencies in existing scribing approaches. Many embodiments can provide for improved monitoring and position control through improved illumination and detection of scribe lines. Systems in accordance with many embodiments provide for general purpose, high-throughput, direct patterning laser scribing on large film-deposited substrates. Such systems allow for bi-directional scribing, patterned scribing, arbitrary pattern scribing, and/or adjustable pitch scribing, without changing an orientation of the workpiece, and with real-time monitoring of relative scribe positions. Such systems can also monitor scribing in real time to make on-the-fly position adjustments.

Methods and systems in accordance with many embodiments provide a laser scribing system using simple longitudinal workpiece movement and multiple laser scanners to scribe workpieces such as solar-cell devices. The workpiece may move longitudinally during scribing, and lasers direct beams to translatable scanners that direct the light up through the substrate to the film(s) being scribed. A combination of illumination sources can be used for real-time monitoring of scribe position relative to previously-formed scribe lines, even when the monitored scribe lines comprise lines formed in different layers at different depths and in different materials of a workpiece.

For example, imaging and position detection of scribed patterns in a stack of tandem junction thin-film solar cell can benefit from multiple illumination conditions and configurations. The optical coupling of such illumination sources and control of optical parameters such as wavelength, intensity, exposure time, illumination angle and other parameters relating to the particular thin films or materials may be important for producing the resolution and/or image quality needed for metrology applications, such as line detection and placement of subsequent scribe lines. In many embodiments, illumination wavelengths from 630 nm to 670 nm red are used, although other wavelengths such as green and blue can also be used to illuminate. Collinear and back light illumination can be set perpendicular to the substrate at a suitable working distance. Dark-field illumination can be provided by, for example, a ring light (e.g., a ring light-emitting diode(s)) that provides inwardly-angled illumination at, for example, twenty-five to thirty degrees relative to perpendicular from the workpiece to form uniform illumination at the substrate surface. The working distance of the ring light can be set at, for example, thirty millimeters plus or minus three millimeters from the substrate surface. The resulting signal intensity generated via the dark-field illumination generated by the ring light can be more sensitive to the working distance of the ring light as compared to collinear and back illumination. A suitable camera exposure time can be selected, for example, between zero and 1000 microseconds so as to generate a detection signal with a good signal-to-noise ratio without saturation of the image.

In many embodiments, efficient illumination conditions are beneficial for centroid detection and placement of laser-scribed lines (e.g., a first layer laser-scribed line (“P1” line), a second layer laser scribed line (“P2” line), and a third layer laser-scribed line (“P3” line)) in a thin-film solar cell. Better placement helps to achieve smaller dead zones, resulting in higher solar cell and module efficiency. Various illumination approaches for such scribe line detection can be used that are applicable to textured transparent conductive oxides (TCOs) as light scattering, highly conductive, and transparent front contacts in silicon p-i-n solar cells, as well as to devices with metal back contact layers.

Due to the presence of optical losses in the individual layers of a solar cell structure, the use of multiple illumination sources enables imaging contrast line centroid detection. Such approaches can be used to develop illumination requirements and a roadmap for achieving stable detection accuracy of patterned scribe lines during a scribing process, as may be required for placement accuracy and meeting solar-cell dead-zone targets.

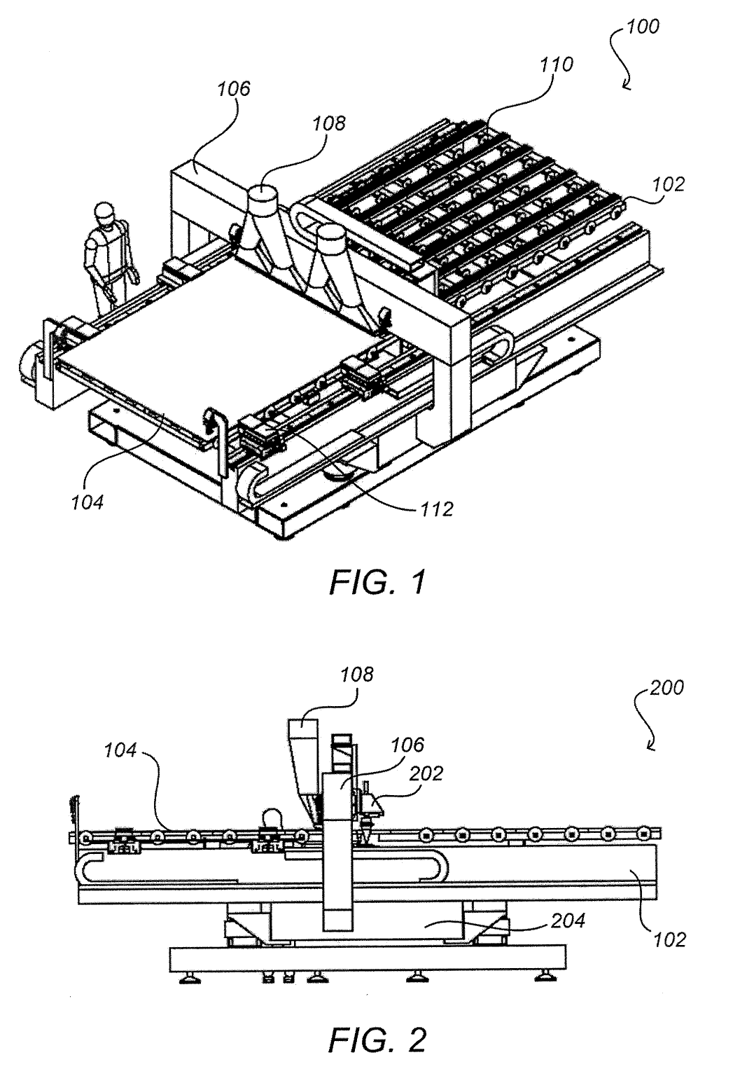

FIG. 1 illustrates an example of a laser-scribing device 100 that can be used in accordance with many embodiments. The device includes a bed or stage 102, which will typically be level, for receiving and maneuvering a workpiece 104, such as a substrate having at least one layer deposited thereon. In one example, a workpiece is able to move along a single directional vector (i.e., for a Y-stage) at a rate of up to about 2 m/s or more. Typically, the workpiece will be aligned to a fixed orientation with the long axis of the workpiece substantially parallel to the motion of the workpiece in the device. The alignment can be aided by the use of cameras or imaging devices that acquire marks on the workpiece. In this example, the lasers (shown in subsequent figures) are positioned beneath the workpiece and opposite an exhaust arm 106 holding part of an exhaust mechanism 108 for extracting material ablated or otherwise removed from the substrate during the scribing process. The workpiece 104 typically is loaded onto a first end of the stage 102 with the substrate side down (towards the lasers) and the layered side up (towards the exhaust). The workpiece is received onto an array of rollers 110 and/or bearings, although other bearing- or translation-type objects can be used to receive and translate the workpiece as known in the art. In this example, the array of rollers all point in a single direction, along the direction of propagation of the substrate, such that the workpiece 104 can be moved back and forth in a longitudinal direction relative to the laser assemblies. The device can include at least one controllable drive mechanism 112 for controlling a direction and translation velocity of the workpiece 104 on the stage 102.

This movement is also illustrated in the side view 200 of FIG. 2, where the substrate moves back and forth along a vector that lies in the plane of the figure. Reference numbers are carried over between figures for somewhat similar elements for purposes of simplicity and explanation, but it should be understood that this should not be interpreted as a limitation on the various embodiments. As the substrate is translated back and forth on the stage 102, a scribing area of the laser assembly effectively scribes from near an edge region of the substrate to near an opposite edge region of the substrate. In order to ensure that the scribe lines are being formed properly, an imaging device can image at least one of the lines after scribing. Further, a beam profiling device 202 can be used to calibrate the beams between processing of substrates or at other appropriate times. In many embodiments where scanners are used, for example, which drift over time, a beam profiler allows for the calibrating of the beam and/or adjustment of beam position. The stage 102, exhaust arm 106, and a base portion 204 can be made out of at least one appropriate material, such as a base portion of granite.

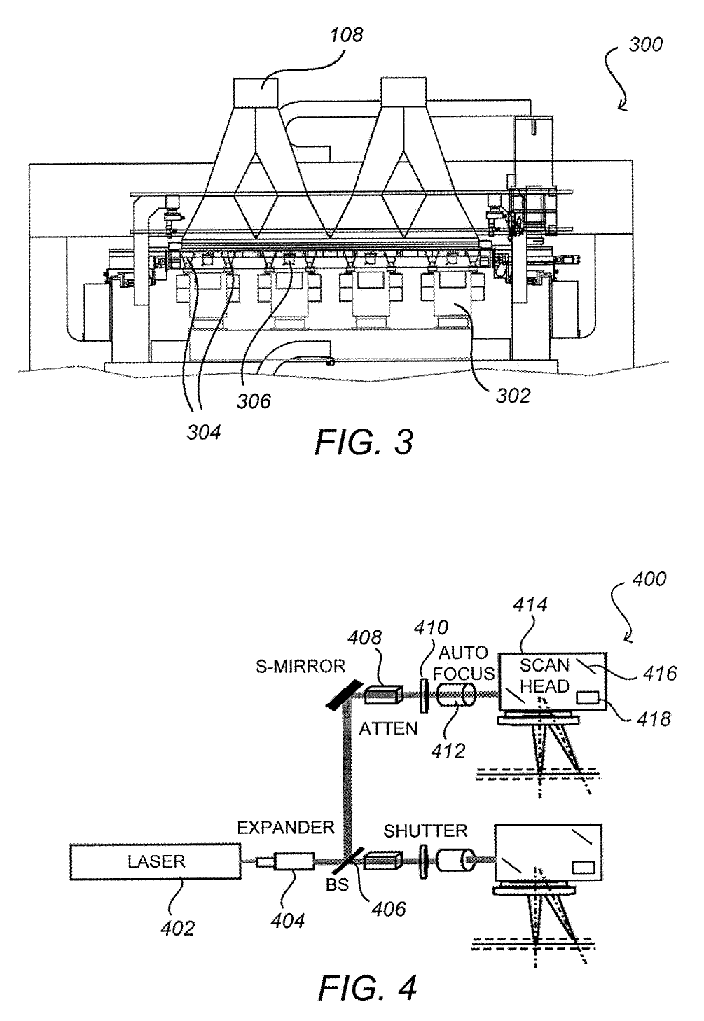

FIG. 3 illustrates an end view 300 of the example device, illustrating a series of laser assemblies 302 used to scribe the layers of the workpiece. In this example, there are four laser assemblies 302, each including a laser device and elements, such as lenses and other optical elements, needed to focus or otherwise adjust aspects of the laser. The laser device can be any appropriate laser device operable to ablate or otherwise scribe at least one layer of the workpiece, such as a pulsed solid-state laser. As can be seen, a portion of the exhaust 108 is positioned opposite each laser assembly relative to the workpiece, in order to effectively exhaust material that is ablated or otherwise removed from the workpiece via the respective laser device. In many embodiments, the system is a split-axis system, where the stage translates the sample along a longitudinal axis. The lasers then can be attached to a translation mechanism able to laterally translate the lasers 302 relative to the workpiece 104. For example, the lasers can be mounted on a support that is able to translate on a lateral rail as driven by a controller and servo motor. In many embodiments, the lasers and laser optics all move together laterally on the support. As discussed below, this allows shifting scan areas laterally and provides other advantages.

In this example, each laser device actually produces two effective beams 304 useful for scribing the workpiece. As can be seen, each portion of the exhaust 108 covers a scan field, or an active area, of the pair of beams in this example, although the exhaust could be further broken down to have a separate portion for the scan field of each individual beam. The figure also shows substrate thickness sensors 306 useful in adjusting heights in the system to maintain proper separation from the substrate due to variations between substrates and/or in a single substrate. Each laser can be adjustable in height (e.g., along the z-axis) using a z-stage, motor, and controller, for example. In many embodiments, the system is able to handle 3-5 mm differences in substrate thickness, although many other such adjustments are possible. The z-motors also can be used to adjust the focus of each laser on the substrate by adjusting the vertical position of the laser itself.

In order to provide the pair of beams, each laser assembly includes at least one beam splitting device. FIG. 4 illustrates basic elements of an example laser assembly 400 that can be used in accordance with many embodiments, although it should be understood that additional or other elements can be used as appropriate. In this assembly 400, a single laser device 402 generates a beam that is expanded using a beam expander 404 then passed to a beam splitter 406, such as a partially transmissive mirror, half-silvered mirror, prism assembly, etc., to form first and second beam portions. In this assembly, each beam portion passes through an attenuating element 408 to attenuate the beam portion, adjusting an intensity or strength of the pulses in that portion, and a shutter 410 to control the shape of each pulse of the beam portion. Each beam portion then also passes through an auto-focusing element 412 to focus the beam portion onto a scan head 414. Each scan head 414 includes at least one element capable of adjusting a position of the beam, such as a galvanometer scanner useful as a directional deflection mechanism. In many embodiments, this is a rotatable mirror able to adjust the position of the beam along a lateral direction, orthogonal to the movement vector of the workpiece, which can allow for adjustment in the position of the beam relative to the intended scribe position. The scan heads then direct each beam concurrently to a respective location on the workpiece. A scan head also can provide for a short distance between the apparatus controlling the position for the laser and the workpiece. Therefore, accuracy and precision is improved. Accordingly, the scribe lines may be formed more precisely (i.e., a scribe 1 line can be closer to a scribe 2 line) such that the efficiency of a completed solar module is improved over that of existing techniques.

In many embodiments, each scan head 414 includes a pair of rotatable mirrors 416, or at least one element capable of adjusting a position of the laser beam in two dimensions (2D). Each scan head includes at least one drive element 418 operable to receive a control signal to adjust a position of the “spot” of the beam within the scan field and relative to the workpiece. In one example, a spot size on the workpiece is on the order of tens of microns within a scan field of approximately 60 mm×60 mm, although various other dimensions are possible. While such an approach allows for improved correction of beam position on the workpiece, it can also allow for the creation of patterns or other non-linear scribe features on the workpiece. Further, the ability to scan the beam in two dimensions means that any pattern can be formed on the workpiece via scribing without having to rotate the workpiece.

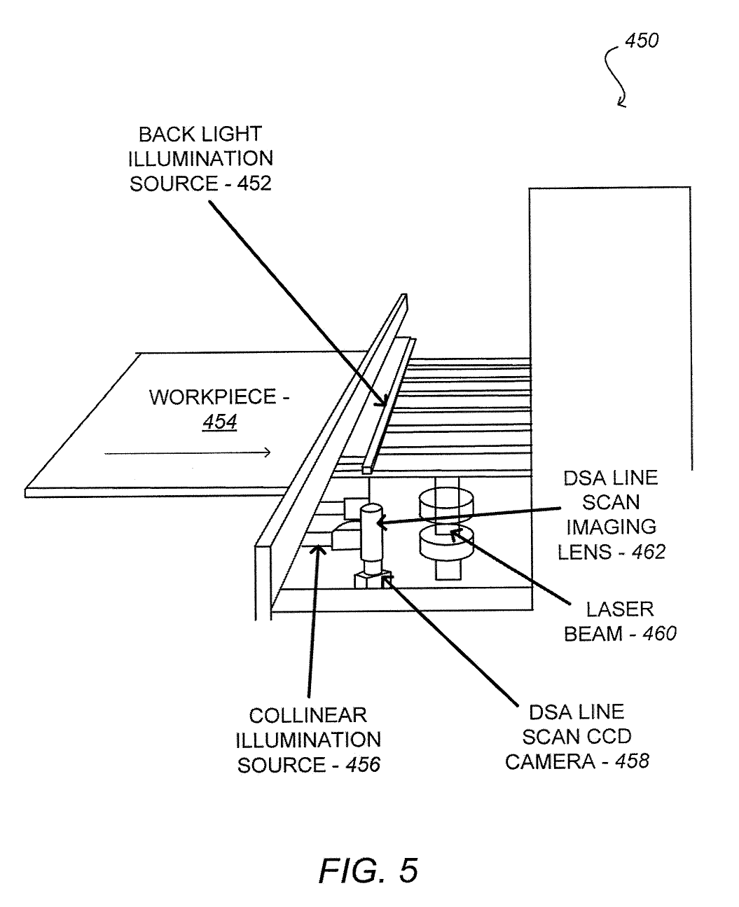

FIG. 5 illustrates a laser-scribing device 450 in accordance with many embodiments. The laser-scribing device 450 includes a back light illumination source 452 for illuminating a workpiece 454 from above, a collinear illumination source 456 for illuminating the workpiece 454 from below, an imaging device 458 for capturing images of the workpiece, a laser 460, and a imaging device lens 462. In many embodiments, the collinear illumination source 456 is substantially inline with the laser path, such as the path illustrated in FIG. 4. In many embodiments, the collinear illumination source 456 is configured with at least one optical element to produce a beam along the optical path, directing light from the collinear source, to be reflected by the workpiece back through the imaging device lens 462, and ultimately received to the imaging device 458 (e.g., a line scan charge-coupled-device (“CCD”) camera or other such detector). As discussed later herein, such a collinear illumination source 456 can be used to image specific structures. For other structures, however, the back light illumination source 452 can be used, individually or in combination with the collinear illumination source 456. In many embodiments, the back light illumination source 452 is a bar light-emitting diode (“LED”) or other appropriate source of illumination that is able to illuminate the imaging region(s) of the workpiece from the side opposite the lasers (the top in the figure), as opposed to the collinear illumination source 456, which illuminates the workpiece from the same side (bottom in the figure) as the lasers. Such illumination allows detection of multiple scribe lines during scribing, such that relative positions can be detected and dead zones minimized.

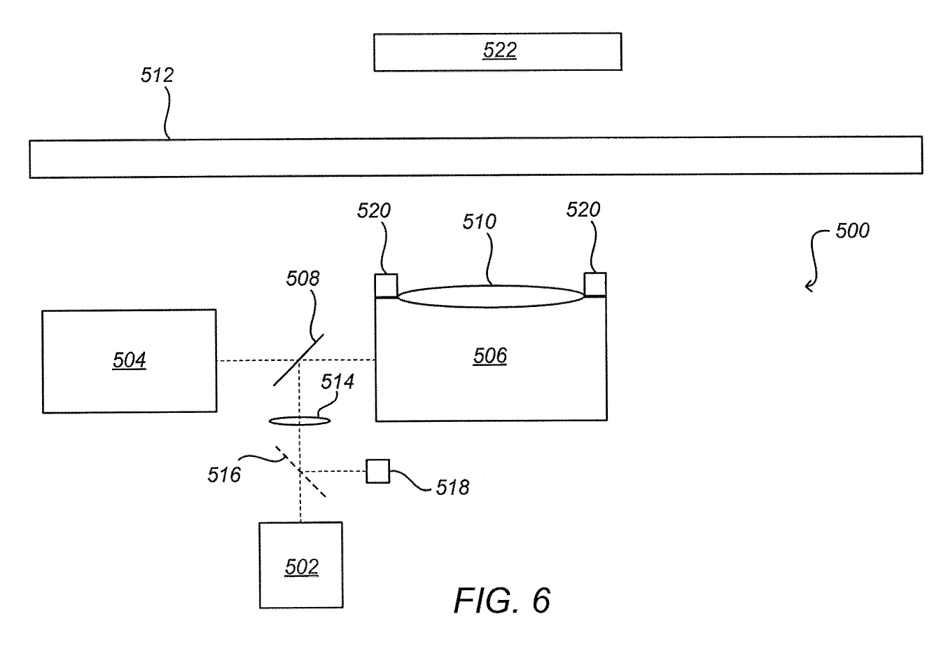

FIG. 6 diagrammatically illustrates a laser-scanning assembly 500 having an integrated camera 502, in accordance with many embodiments. The laser-scanning assembly 500 includes a laser 504 that supplies a laser beam to a scan head 506. The laser beam passes through a dichroic beam splitter 508 on its way to the scan head 506. The scan head 506 can include at least one element capable of adjusting a position of the laser beam, such as a galvanometer scanner useful as a directional deflection mechanism. The scan head 506 includes a telecentric scan lens 510 that can provide for redirection of a scanned laser beam so as to impinge upon a workpiece 512 in a direction that is substantially normal to the workpiece 512. The camera 502 is integrated so as to view the workpiece through the scan head. The camera 502 can be used to capture light that is reflected from and/or transmitted through the workpiece. The light from the workpiece travels through the telecentric lens 510, is redirected by the scan head toward the laser 504, is reflected by the dichroic beam splitter 508, travels through an imaging lens 514, travels through the beam splitter 516, and then is received by the camera 502.

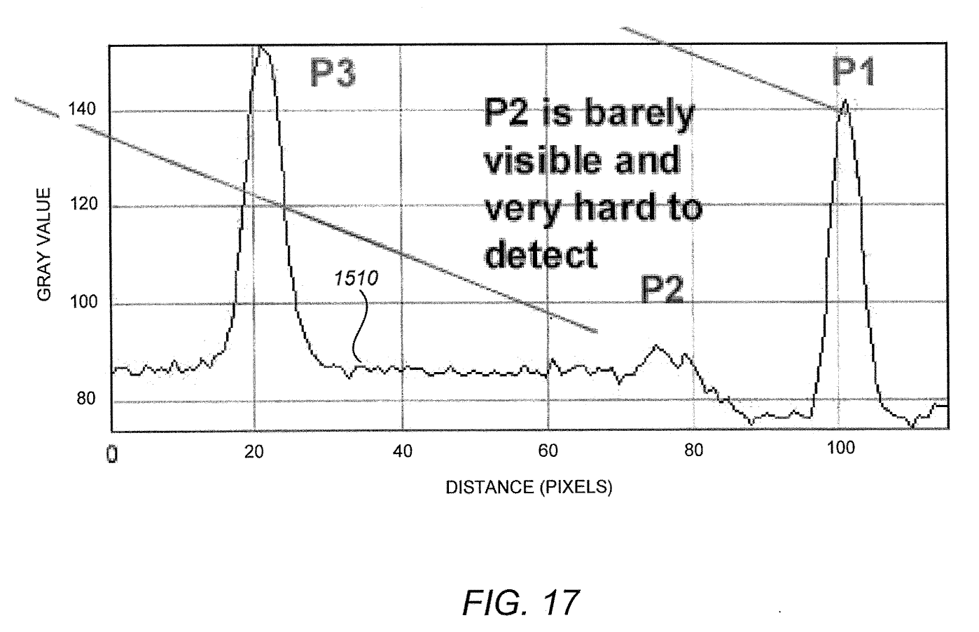

The laser-scanning assembly 500 includes illumination sources for collinear illumination, back illumination, and for dark-field illumination. Light from a collinear illumination source 518 is reflected by the beam splitter 516 so as to be directed through the imaging lens 514 towards the beam splitter 508. The beam splitter 508 redirect the light toward the scan head 506, which in turn redirects the light toward the workpiece 512. A dark-field illumination source 520 (e.g., a ring-light comprising a light emitting diode(s)) emits inwardly-angled illumination light for dark-field illumination of the workpiece 512. As will be described in more detail below with regard to FIGS. 17 to 19, such dark-field illumination can be used for effective detection of P2 scribe lines after the deposition of a back metal layer. A back illumination source 522 is located above the workpiece 512. The illumination sources 518, 520, 522 can be located in other suitable locations (other than those illustrated) so as to supply collinear illumination, back illumination, and/or dark-field illumination of the workpiece 512.

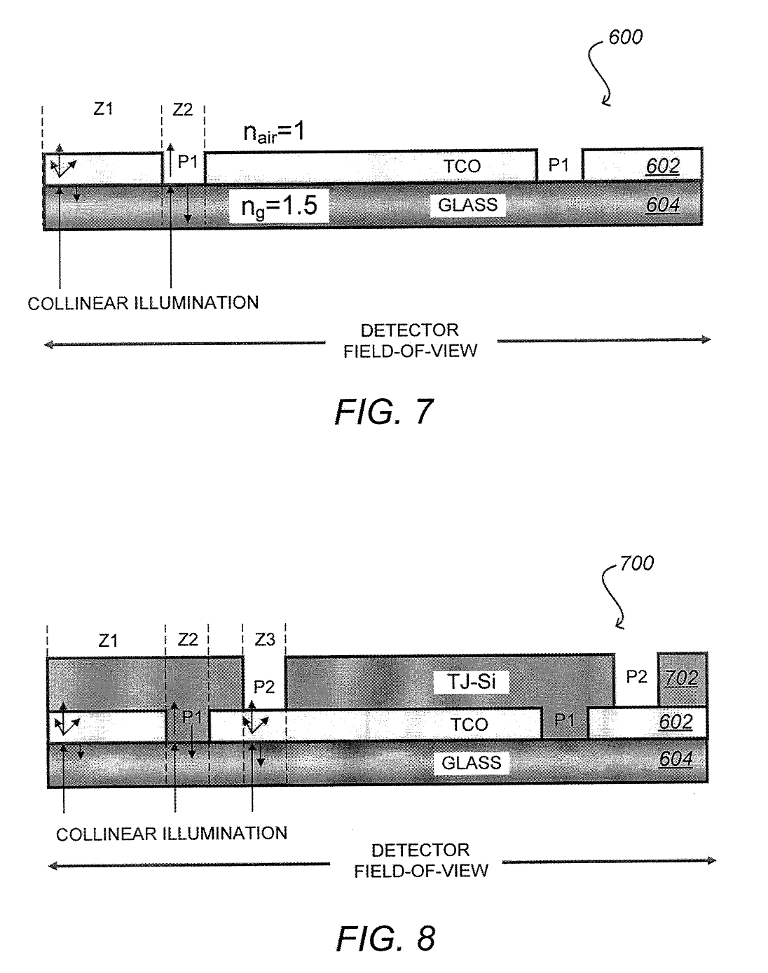

FIG. 7 illustrates a workpiece 600 having a first layer of material 602 (here TCO) deposited on a substrate 604 (here glass). As can be seen, the layer of TCO has been etched to form P1 lines at the appropriate locations. A collinear illumination source can be used to illuminate the workpiece from the same direction as the lasers (from the bottom in the figure). As can be seen, the light passes through the glass and is reflected by the glass/TCO interface by a first amount. The TCO tends to scatter a percentage of the incident light, reflecting a small percentage back to the center while transmitting a large portion of the light. In areas of the P1 scribe line (see zone two or “Z2”) there is no TCO present, such that the light is either reflected by the glass/air interface (a different percentage due to the different refractive indices of air and TCO) or transmitted through the glass. According to the laws of geometric optics, light transmitted through the bottom surface of the glass is reflected by the top surface of the glass (n_{glass}>nₐᵢᵣ). The remaining light passes through the P1 scribe line. The difference in reflected light at different regions thus can be captured by a sensor (e.g., a CCD sensor) to detect the position of the P1 lines. A centroid or other mathematical location can be calculated, based on the detected light, to determine an approximate position of each P1 line. Good image contrast can be obtained using collinear light having a controlled intensity and an appropriate CCD exposure time so as to produce a usable signal-to-noise ratio (i.e., signal to background). Preferably, the signal-to-noise ratio is at least three to one. In many embodiments, the exposure time can be from zero to 1000 microseconds, as long as the signal does not get saturated and the signal-to-noise ratio produced provides for reliable detection (e.g., signal-to-noise ratio greater than three).

FIG. 8 illustrates a workpiece 700 having a second layer of material 702 (here silicon) deposited on a the first layer 602. As can be seen, the layer of silicone (“TJ-Si”) has been etched to form P2 lines, and the TJ-Si has filled in the P1 lines. A collinear illumination source can be used to again illuminate the workpiece. The glass will reflect a different portion of the light at the P1 lines, but this time the amount of light reflected will differ due to the differing indexes of refraction of TJ-Si and air. In zone 1, where there is a TCO layer over the glass, the TCO tends to scatter (via diffuse reflection) most of the incident light passing through the glass and reflects a small portion. The percentage of light that passes through the TCO is absorbed by the TJ-Si light-trapping layers, whereas the remaining gets transmitted through the TJ-Si to the other side, then lost during detection. Some of the light that crosses the TCO to the TJ-Si gets reflected back to the TCO, and a large portion of this light is scattered again by the TCO. A small percentage is transmitted back to the detector optics, causing a uniform rise in the detection threshold value.

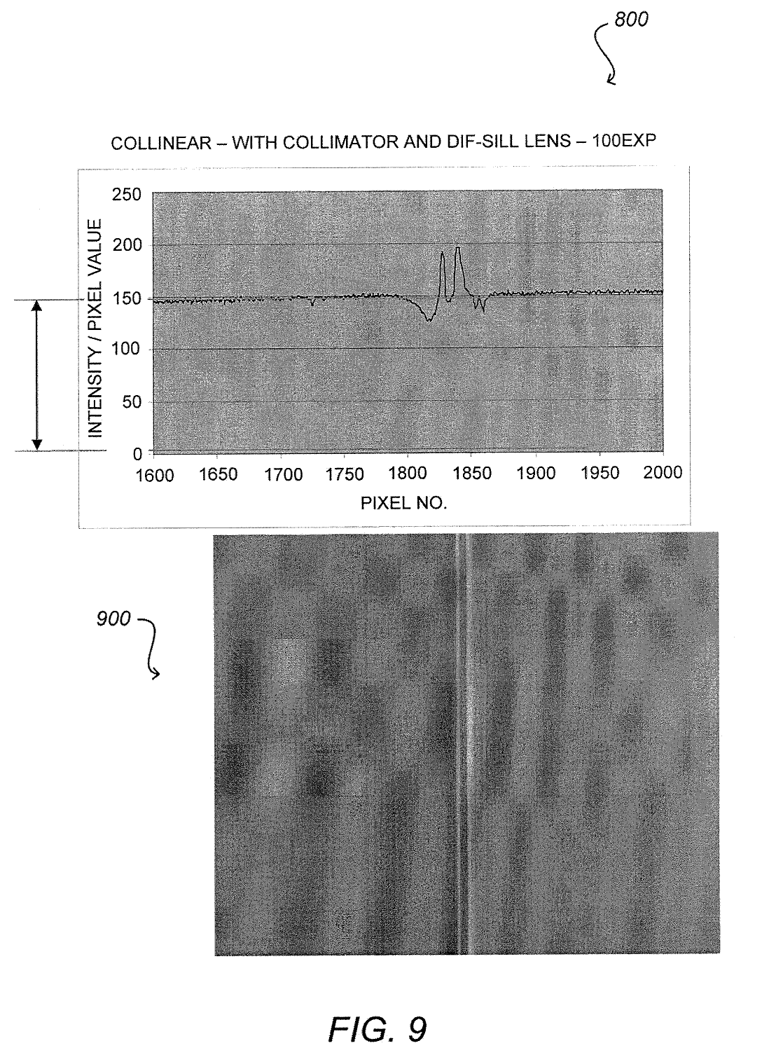

In zone 2, corresponding to the P1 scribe zone, a portion of the light is reflected (via specular reflection) by the glass/TJ-Si interface, which passes through the glass back to the CCD sensor to produce adequate signal intensity (i.e., signal-to-noise) for detection of the P1 scribe position. No major diffuse-scattering of light by the TCO layer takes place in this zone, only absorption and specular reflection. In zone 3, corresponding to the P2 scribe in the second layer over the TCO, light is transmitted through the TCO layer and passes through the P2 opening. The TCO interface with the glass scatters some of the incident light, and reflects back a small percentage of the light to the detector, compared with the reflection at zone 1 (nₐᵢᵣ<nₛᵢ). Thus, a small amount of light will be reflected from zone 3, but the light will be a small percentage of scattered light. FIG. 9 illustrates a plot 800 of the collinear light interaction with the TCO and TJ-Si layers during a P2 scribing process, where relative positions of the P1 and P2 lines can be detected. FIG. 9 also illustrates an image 900 used to generate the plot 800.

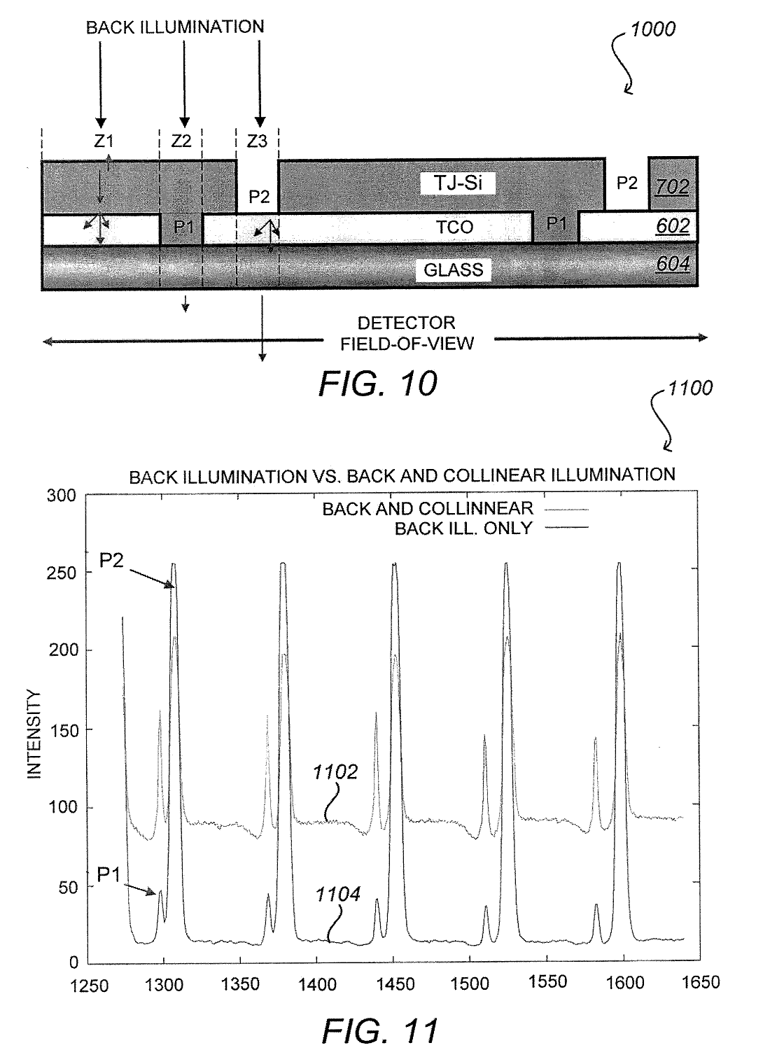

FIG. 10 illustrates the same workpiece state as in FIG. 8, but in this case illustrates the effects of back illumination, coming from above the workpiece 1000 in the figure. As can be seen, in zone 1 where there is no scribing, a percentage of the incident light is absorbed in the silicon layer (light-trapping effect), whereas the remaining light is scattered by the TCO (by diffuse reflection), such that a very small percentage of the light (depending upon the intensity) is transmitted through the glass and to the imaging sensor. In zone 2, where the P1 line exists, a percentage of light that is not absorbed in the TJ-Si layer is transmitted through the glass and reaches the imaging sensor to produce a small P1 signal of good contrast, just above the threshold. However, the signal-to-noise ratio is not sufficient for P1 detection, such that collinear illumination is preferable (or at least useful) for P1 detection after formation of the TJ-Si layer. Again, due to the absence of TCO in this zone, there is no diffuse-scattering of light in zone 2.

In zone 3, corresponding to the P2 line in the silicon layer, the TCO layer diffuse-scatters a percentage of the incident light. However, due to the large (non-attenuated) intensity of the back illumination, the light is substantially transmitted through the TCO and glass to the CCD sensor, producing a strong signal for the position of the P2 line with a very good signal-to-noise ratio.

FIG. 11 illustrates a plot 1100 of the positions of the P1 and P2 lines as detected using back illumination, and a combination of back and collinear illumination. A trace 1102 is generated using a combination of back illumination and collinear illumination. A trace 1104 is generated using back illumination alone. As can be seen, a very strong signal is detected for the position of the P2 lines. Although not as strong as the P2 signal, a notable signal is detected for the position of the P1 lines.

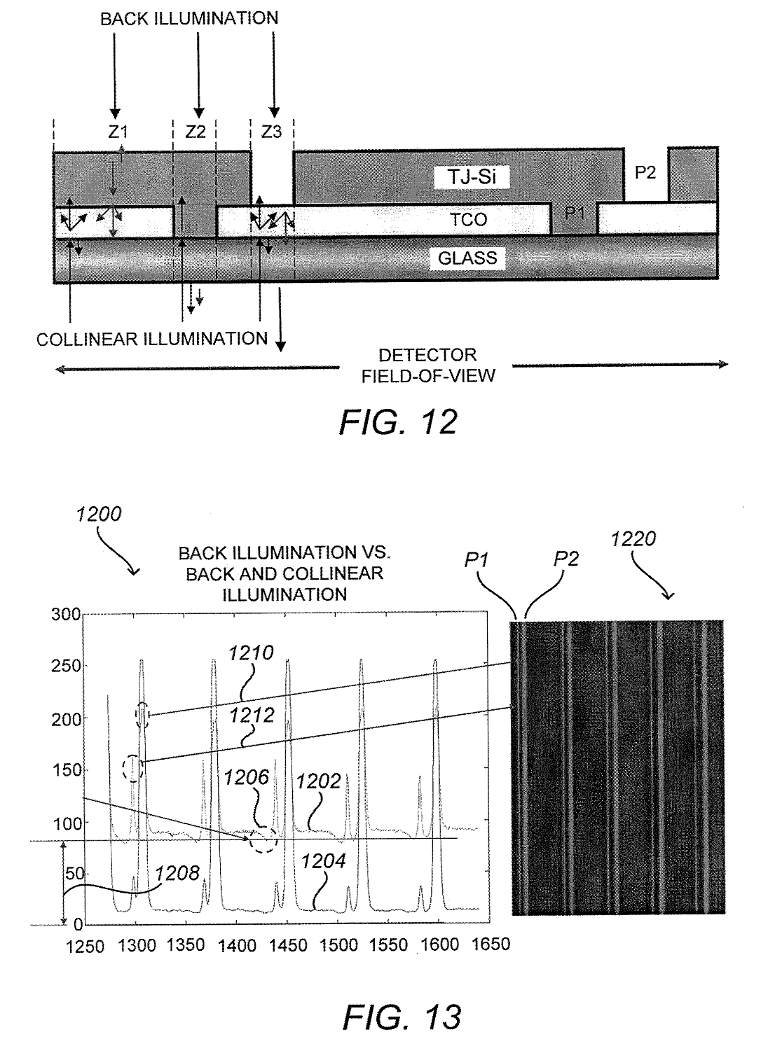

FIG. 12 illustrates the workpiece of FIGS. 8 and 10, but with a combination of collinear and back illumination. In zone 1, a percentage of the light gets scattered (via diffuse reflection) by the TCO layer, whereas another percentage is absorbed by the TJ-Si layer. A percentage of the light that is reflected back by TJ-Si and/or TCO layers to the CCD sensor causes a uniform rise in threshold, as seen in FIG. 13. Thus, an adjustment of the light intensity of both the collinear and back light sources can be desirable to optimize the threshold and maximize the signal-to-noise ratios, as well as to avoid sensor signal saturation. In zone 2, corresponding to the P1 line, collinear light is responsible for the P1 signal-to-noise ratio. However, a portion of the back light that is not absorbed in the TJ-Si may get transmitted through the glass, to be summed up with the reflected collinear light, which enhances the P1 signal. In zone 3, the TCO diffuse-scatters a percentage of the incident light. Due to the large percentage of back illumination that is transmitted through the TCO and glass to the CCD sensor, however, a strong signal with good signal-to-noise is produced. FIG. 13 illustrates a plot 1200 with back illumination compared with combined illumination. As can be seen, the combined results produce strong signals for both P1 and P2 with good signal-to-noise ratios. FIG. 13 also illustrates an image 1220 used to generate the plot 1200.

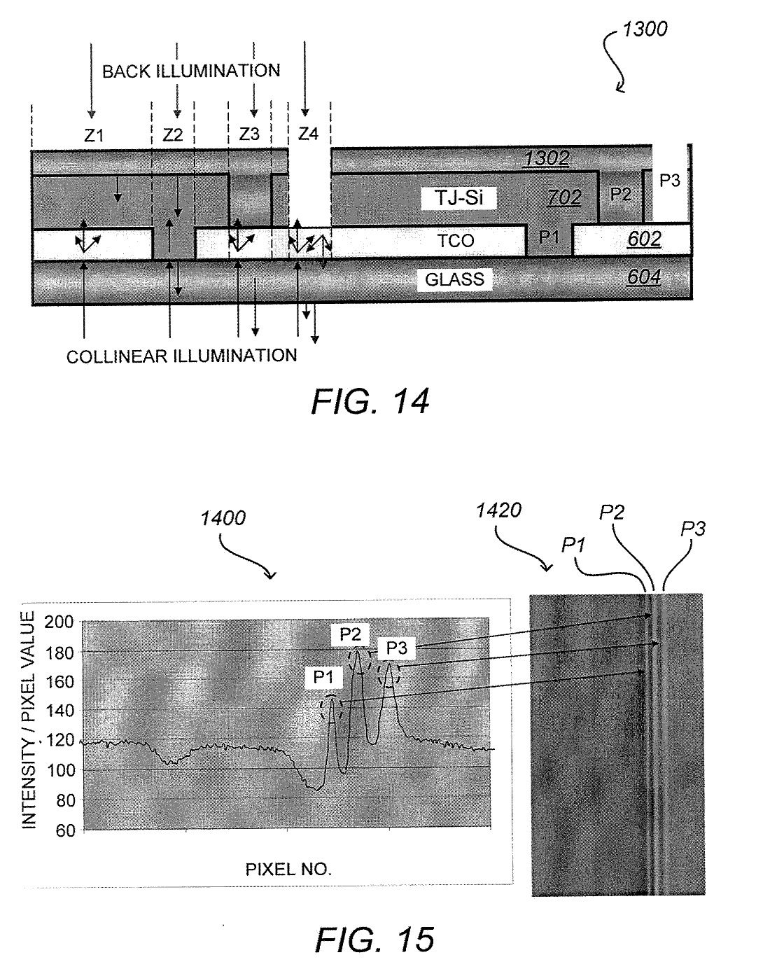

FIG. 14 illustrates a workpiece 1300 that includes a third layer of material 1302 (here a back metal layer) deposited on the second layer 702. As can be seen, the back metal and TJ-Si layers have been etched to form P3 lines, with the TCO being exposed at the P3 lines (zone 4). In zone 1, a percentage of the collinear illumination light is scattered (via diffuse reflection) by the TCO layer and absorbed by the TJ-Si layer, and a percentage of light that passes through the TJ-Si layer gets reflected by the back metal layer. Percentages of this reflected light are then absorbed or scattered by the TCO layer, with the remaining transmitted percentage being substantially transmitted back to the imaging device, causing a uniform rise in the threshold. Almost no back light is transmitted through the back metal layer in this zone.

In zone 2, corresponding to the P1 line that is now substantially filled in with TJ-Si, the TJ-Si diffuse-scatters a percentage of the incident light from collinear illumination. However, a large percentage of light that is transmitted through the TJ-Si layer is reflected by back metal layer to enter the detector while producing a good P1 signal-to-noise ratio. In zone 3, the back light is substantially blocked by back metal layer before reaching the TJ-Si layer, so the collinear light is responsible for creating a P2 signal. In zone 4, corresponding to the P3 scribe, the TCO layer diffuse-scatters a percentages of the incident light from both the collinear and back light. However, the direct illumination and high intensity of the back illumination means that a large percentage of the back light reaches the detector and contributes to the P3 signal detection. FIG. 15 illustrates a plot 1400 showing the P1, P2, and P3 detected positions using a combination of collinear and back light illumination. As can be seen, each of the peaks can be resolved with a strong peak and a good signal-to-noise ratio. FIG. 15 also illustrates an image 1420 used to generate the plot 1400.

When implementing back light illumination in such a system, however, it can be undesirable in some embodiments to place a light source above the ablation zone(s), as the source will generally be in the debris path (between the ablation sites and the exhaust) which can lead to various problems with contamination, etc., as known in the art. Accordingly, an angled metal reflector, or similar reflective component, can be placed relative to the workpiece such that a light source from a side of the device, for example, can direct a beam toward the reflector, which can direct the beam down toward the workpiece. A metal reflector can be made from any appropriate metal, such as aluminum, and can have any coating, shape, or other aspect that can help to reduce contamination while substantially reflecting the incident light. In many embodiments, the light source is a bar LED emitting light in the range of 630-650 nm, with an appropriate intensity for the materials being scribed. In many embodiments, the reflector is a metal reflector with a low polishing quality finish surface, mounted at angle to reflected light from an LED mounted outside the ablation area. The use of a reflector may produce substantially the same image quality and centroid detection capability as that of direct back illumination.

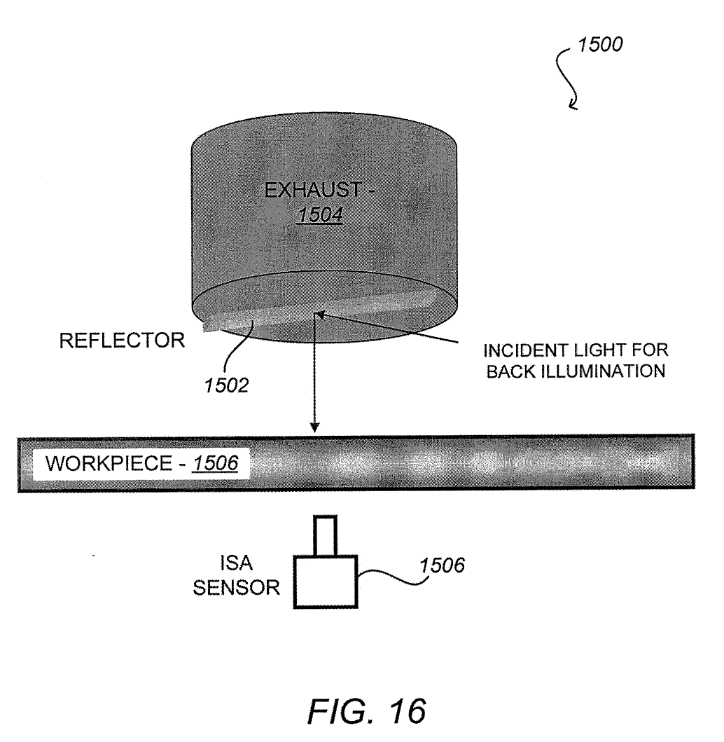

FIG. 16 illustrates such an illumination configuration 1500, in accordance with many embodiments. The illumination configuration 1500 includes a reflector 1502 mounted to an exhaust nozzle 1504. The exhaust nozzle 1504 is positioned above a workpiece 1506 so as to capture material ablated from the workpiece 1506. The reflector 1502 is used to reflect light onto the workpiece from a back illumination source (not shown). A sensor 1506 is positioned below the workpiece 1506 so as to capture images for processing to locate the scribe line features.

Dark-Field Illumination Detection of P2 Lines

In some instances, the use of collinear illumination to detect P2 scribe lines following the deposition of a metal back layer can result in a detection signal with an undesirably low signal-to-noise ratios for some P2 scribe lines. Such a low signal-to-noise ratio may be attributable to the P2 scribe line being located behind the TCO layer, which diffuses-scatters the collinear illumination light as described above. For example, FIG. 17 illustrates an example detection signal 1510 that was generated using collinear and back illumination. The signal 1510 exhibits a good signal-to-noise ratio corresponding to the P1 and P3 scribe lines, but exhibits a poor signal-to-noise ratio corresponding to the P2 scribed line.

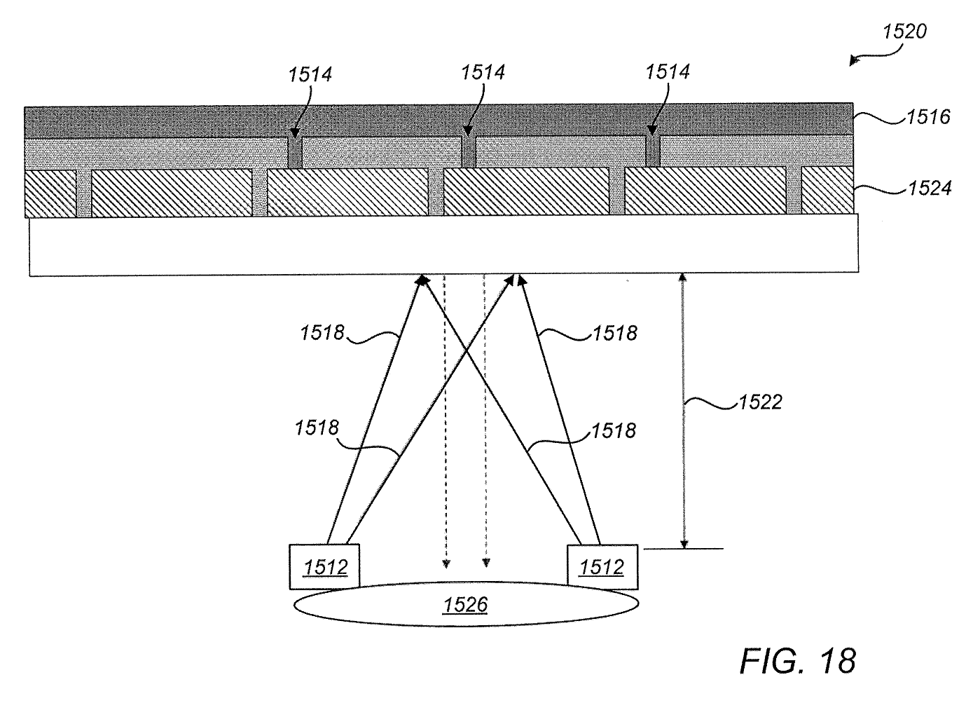

FIG. 18 illustrates the use of a ring light 1512 (e.g., ring led(s)) to generate dark-field illumination to detect P2 scribe lines 1514 in the presence of a metal back layer 1516. The ring light 1512 projects inwardly-angled illumination light 1518 toward a workpiece 1520. In many embodiments, the illumination light is angled between 25 and 30 degrees relative to perpendicular to the workpiece 1520. The ring light 1512 can be set at a suitable working distance 1522 (e.g., thirty millimeters plus or minus three millimeters) from the surface of the workpiece 1520 to generate a detection signal having a good signal-to-noise ratio given the illumination intensities, angles, and coverage areas used. The dark-field illumination reduces background reflection generated noise levels in the detection signal. The ring light 1512 increases the level of light to which the TCO layer 1524 is subjected, thereby increasing the resulting level of light that interacts with the P2 scribe line 1514 on the other side of the TCO layer 1524. Increased light interaction with the P2 scribe line 1514 results in increased amount of light ultimately transmitted back to the imaging device via the scanning lens 1526 of the scan head, which helps to increase the signal-to-noise ratio of the resulting detection signal.

Scribe line detection using ring-light generated dark-field illumination can involve a number of considerations. In many embodiments, the ring light 1512 is configured to illuminate a circular region on the surface of the workpiece that is at least as big as the field-of-view of the imaging device being used. For example, the ring light 1512 can be configured to illuminate a circular area of 30 mm or greater when a CCD sensor having a 28 mm field-of-view is used. In many embodiments, the ring light 1512 emits illumination with a wavelength of 630 plus or minus 10 nm, although other illumination wavelengths can be used. Preferably, the light intensity over the circular area will not vary more than 10 percent. In many embodiments, controlling the working distance of the ring light 1512 within plus or minus 3 mm serves to avoid working distance related variations in the light intensity over the circular area. In many embodiments, the rise and fall time of the CCD sensor is less than 10 microseconds, so that the exposure time used is not significantly dictated by the CCD sensor rise and fall time. Preferably, the aperture used to expose the CCD sensor is selected to be large enough to cover the desired field-of-view, and yet small enough to maintain at least F/11 optics. In many embodiments, the ring light 1512 fits around the scanning lens of a laser scan head (e.g., scan head 506 shown in FIG. 6).

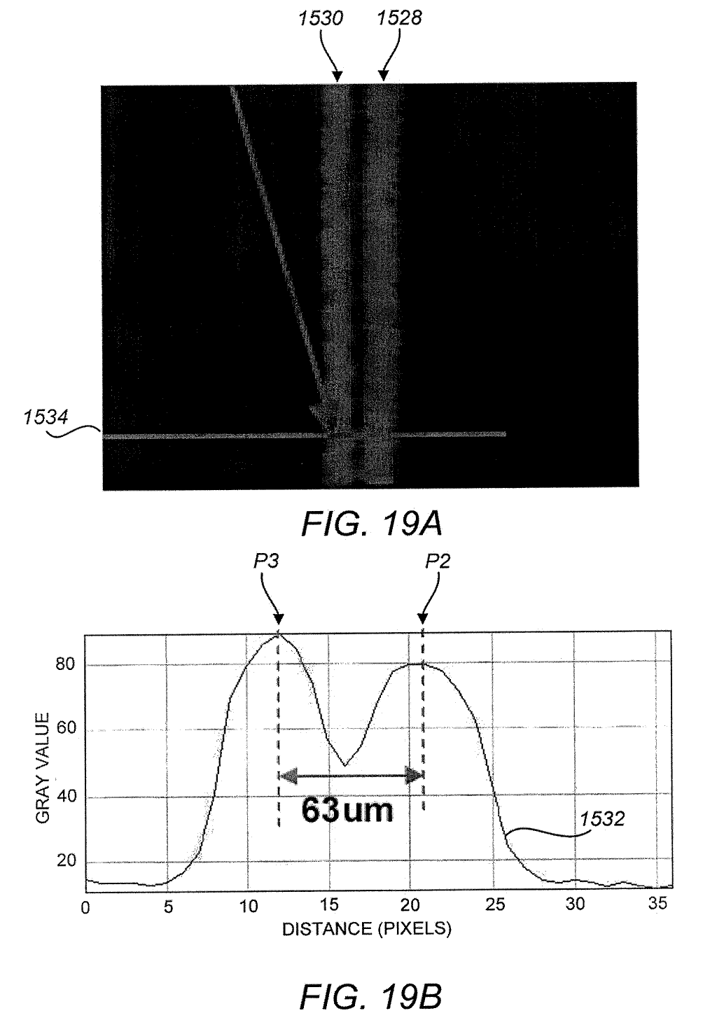

FIG. 19A shows an image of a P2 scribe line 1528 and an adjacent P3 scribe line 1530 that was generated using combined back illumination and dark-field illumination via a ring light. FIG. 19B shows a graph of a detection signal 1532 corresponding to a cross section 1534 of the image of FIG. 19A. As shown, the use of the above described dark-field illumination via a ring light as described in FIG. 18 produces a detection signal 1532 with a good signal-to-noise ratio for the P2 scribe line.

Example Solar Cell Assemblies and Scribe Line Patterns

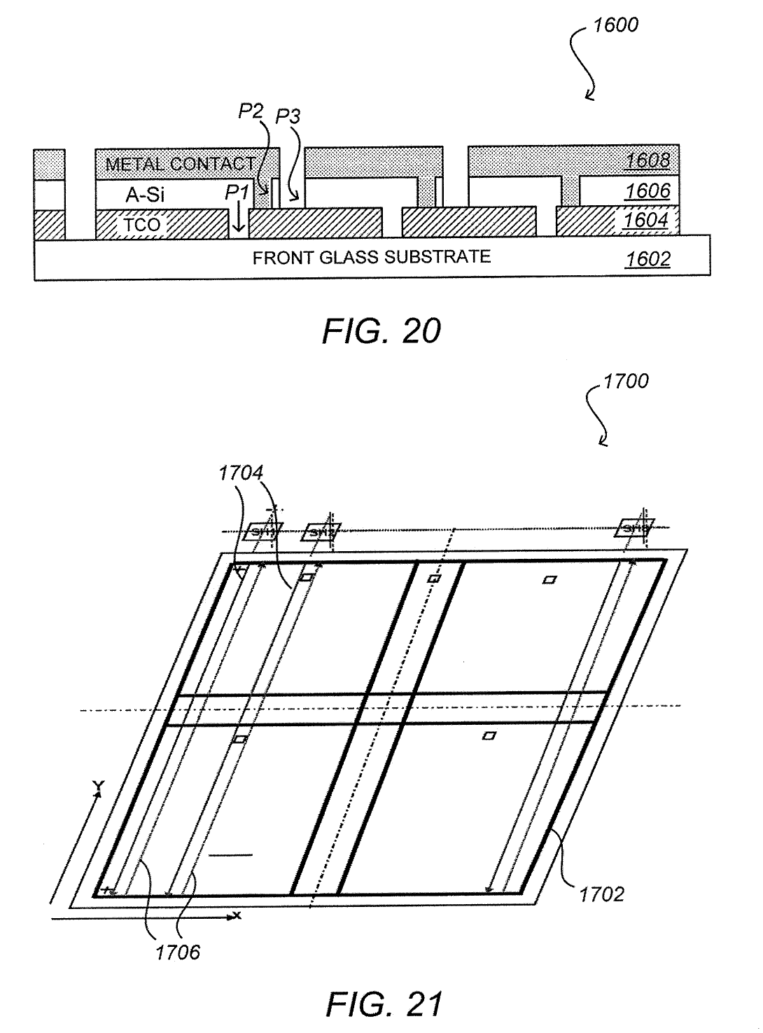

As discussed, such a device can be used in one application to monitor and adjust in real time the position of scribe lines in multi junction solar cell panels. FIG. 20 illustrates an example structure 1600 of a set of thin film solar cells that can be formed in accordance with one embodiment. In this example, a glass substrate 1602 has deposited thereon a layer of a transparent conductive oxide (TCO) 1604, which then has scribed therein a pattern of first scribe lines (e.g., scribe 1 lines or P1 lines). A layer of amorphous silicon 1606 is deposited, and a pattern of second scribe lines (e.g., scribe 2 lines or P2 lines) formed therein. A metal back layer 1608 is deposited, and a pattern of third scribe lines (e.g., scribe 3 lines or P3 lines) formed therein. As discussed, the area between adjacent P1 and P3 (including P2 therebetween) lines is a non-active area, or dead zone, which is desired to be minimized in order to improve efficiency of the overall array. Accordingly, it is desirable to control the formation of the scribe lines and/or the spacing therebetween, as precisely as possible. The ability to capture scribe line position in real time using collinear and back illumination improves other attempts to provide such control.

FIG. 21 illustrates an approach 1700 for scanning a series of longitudinal scribe lines on a workpiece 1702 to form such a device. As shown, the substrate is moved continually in a first direction, wherein the scan field for each beam portion forms a scribe line 1704 moving “down” the substrate. In this example, the workpiece is then moved relative to the laser assemblies, such that when the substrate is moved in the opposite direction, each scan field forms a scribe line going “up” the workpiece (directions used for describing the figure only), with the spacing between the “down” and “up” scribes being controlled by the lateral movement of the workpiece relative to the laser assemblies. In this case, the scan heads may not deflect each beam at all. The laser repetition rate can simply be matched to the stage translation speed, with a necessary region of overlap between scribe positions for edge isolation. At the end of a scribing pass, the stage decelerates, stops, and re-accelerates in the opposite direction. In this case, the laser optics are stepped according to the required pitch so that the scribe lines are laid down at the required positions on the glass substrate. If the scan fields overlap, or at least substantially meet within a pitch between successive scribe lines, then the substrate does not need to be moved relative to the laser assemblies, but the beam position can be adjusted between “up” and “down” movements of the workpiece in the laser scribe device. In another embodiment, the laser can scan across the workpiece making a scribe mark at each position of a scribe line within the scan field, such that multiple scribe longitudinal scribe lines can be formed at the same time with only one complete pass of the workpiece being necessary. Many other scribe strategies can be supported as would be apparent to one of ordinary skill in the art in light of the teachings and suggestions contained herein.

In many embodiments, scribe placement accuracy is guaranteed by synchronizing the stage encoder pulses to the laser and spot placement triggers. The system can ensure that the workpiece is in the proper position, and the scanners directing the beam portions accordingly, before the appropriate laser pulses are generated. Synchronization of all these triggers is simplified by using a single VME controller to drive all these triggers from a common source. Various alignment procedures can be followed for ensuring alignment of the scribes in the resultant workpiece after scribing. Once aligned, the system can scribe any appropriate patterns on a workpiece, including fiducial marks and bar codes in addition to cell delineation lines and trim lines.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method for measuring a position of at least one scribed feature on a workpiece, the workpiece including a substrate and at least one layer used for forming a solar cell, the method comprising:
illuminating the workpiece from a first side of the workpiece with at least one of a first illumination device in a direction substantially perpendicular to the workpiece or a second illumination device that emits angled illumination for dark-field illumination of the workpiece;
illuminating the workpiece with a third illumination device from a second side of the workpiece and in a direction substantially perpendicular to the workpiece, the second side being opposite the first side; and
measuring the amount of light from at least one of the first illumination device or the second illumination device that has been reflected from the workpiece and from the third illumination device that has been transmitted through the workpiece so as to determine a position of at least one scribed feature on the workpiece.

2. The method of claim 1, wherein the step of illuminating the workpiece from a first side of the workpiece comprises emitting angled illumination for dark-field illumination of the workpiece.

3. The method of claim 2, wherein the second illumination device emits light directed between 25 and 30 degrees from perpendicular to the workpiece.

4. The method of claim 2, wherein the second illumination device comprises a ring light.

5. The method of claim 1, wherein the first illumination device is integrated with a laser-scanning assembly so that illumination is projected from the laser-scanning assembly.

6. The method of claim 1, wherein the step of illuminating the workpiece with a third illumination device comprises reflecting illumination light onto the workpiece with a reflector.

7. The method of claim 1, wherein a detector is disposed on the first side of the workpiece so as to accomplish said measuring light.

8. The method of claim 7, wherein the detector is integrated within a laser-scanning assembly so that the light measured by the detector is at least partially transmitted through the laser-scanning assembly.

9. The method of claim 7, wherein the detector comprises a charge-coupled-device (CCD) sensor.

10. The method of claim 1, wherein said measuring light comprises measuring light intensities.

11. An article comprising a storage medium having instructions stored thereon that when executed result in the performance of the following method:
illuminating the workpiece from a first side of the workpiece by using at least one of a first illumination device that illuminates the workpiece in a direction substantially perpendicular to the workpiece or a second illumination device that emits angled illumination for dark-field illumination of the workpiece;
illuminating the workpiece with a third illumination device from a second side of the workpiece and in a direction substantially perpendicular to the workpiece, the second side being opposite the first side; and
measuring the amount of light from at least one the first illumination device or the second illumination device that has been reflected from the workpiece and from the third illumination device that has been transmitted through the workpiece so as to determine a position of at least one scribed feature on the workpiece.

12. A system for measuring a position of at least one scribed feature on a workpiece, the workpiece including a substrate and at least one layer used for forming a solar cell, the system comprising:
a laser generating output able to remove material from at least a portion of a workpiece, the laser being disposed on a first side of the workpiece;
at least one of
a first illumination device operable to illuminate the workpiece from the first side of the workpiece and in a direction substantially perpendicular to the workpiece, or
a second illumination device operable to illuminate the workpiece by emitting angled illumination for dark-field illumination of the workpiece;
a third illumination device operable to illuminate the workpiece from a second side of the workpiece and in a direction substantially perpendicular to the workpiece, the second side being opposite the first side; and
at least one detector operable to measure an amount of light from at least one of the first illumination device or the second illumination device that has been reflected from the workpiece and from the third illumination device that has been transmitted through the workpiece, the detector being further operable to generate a signal corresponding to a position of at least one scribed feature on the workpiece.

13. The system of claim 12, further comprising:
a processor; and
a memory including instructions that when executed by the processor enable the system to analyze the signal from the detector to determine a position of the at least one scribed feature on the workpiece.

14. The system of claim 13, wherein analyzing the signal from the detector comprises determining light intensities.

15. The system of claim 13, further comprising a scanning device operable to control a position of the output from the laser.

16. The system of claim 15, wherein:
the scanning device is integrated with a laser-scanning assembly; and
the first illumination device is integrated with the laser-scanning assembly so that illumination is projected from the scanning device.

17. The system of claim 15, wherein the memory further includes instructions that when executed by the processor enable the system to adjust the position of the output from the laser in order to adjust a relative position of a feature being formed on the workpiece.

18. The system of claim 15, wherein the scanning device is operable to control the position of the output from the laser in two dimensions.

19. The system of claim 15, wherein:
the scanning device is integrated with a laser-scanning assembly; and
at least one detector of said at least one detector is integrated with the laser-scanning assembly so that light measured by the detector comprises light transmitted through the scanning device.

20. The system of claim 12, wherein the at least one detector comprises a charge-coupled-device (CCD) sensor.

21. The system of claim 12, wherein the second illumination device emits light directed between 25 and 30 degrees from perpendicular to the workpiece.

22. The system of claim 12, wherein the second illumination device comprises a ring light.
